(19) United States
(12) Patent Application Publication
(10) Pub. No.: US 2015/0379822 A1
(43) Pub. Date: Dec. 31, 2015

(54) GAMING SYSTEM, APPARATUS AND METHOD

(71) Applicant: Dynamite Services Pty Limited, Sydney (AU)

(72) Inventor: Benjamin James Ellis, Sydney (AU)

(21) Appl. No.: 14/843,260

(22) Filed: Sep. 2, 2015

Related U.S. Application Data
(63) Continuation-in-part of application No. 13/718,117, filed on Dec. 18, 2012.

(30) Foreign Application Priority Data
Sep. 2, 2014 (AU) 2014221197

(51) Int. Cl. G07F 17/32

(52) U.S. Cl. CPC G07F 17/3267

(57) ABSTRACT

A gaming apparatus comprises a display module operable to display play of a wager game comprising a main game having a plurality of stages. A controller of the gaming apparatus evaluates game play to determine whether a stage progression condition has been met and responsive thereto progress play to a subsequent stage. The controller is further operable to set parameters of the main game such that a theoretical Return To Player (RTP) increases for each stage thereof.

### CROSS REFERENCE TO RELATED APPLICATIONS

This application is a continuation-in-part of U.S. patent application Ser. No. 13/718,117 filed Dec. 18, 2012 and claims the benefit of Australia patent application 2014221197 filed Sep. 2, 2014. These applications are incorporated by reference herein.

### FIELD OF THE INVENTION

The present invention relates to gaming systems, game controllers and methods of gaming. It relates for example to electronic gaming machines and to networked gaming systems, such as Internet-based gaming systems.

### BACKGROUND OF THE INVENTION

Gaming machines have been a popular form of entertainment for many years. This popularity has been enhanced with the advent of electronic gaming machines and computer-based gaming systems, such as are provided over the Internet.

Many different types of game are playable on such gaming machines. They include for example standard slot-machine type games with spinning reels, poker machines, keno, bingo, blackjack, roulette, pachinko and the like.

A user will typically place a bet to begin a game, and will win or lose based upon the rules of the game.

While such games provide users with enjoyment, the need exists for alternative gaming systems in order to maintain or increase player enjoyment.

### SUMMARY OF THE INVENTION

According to a first aspect of the invention there is provided a method of gaming comprising: displaying play of a wager game comprising a main game having a plurality of stages with progression through the stages being triggered responsive to determining that a predefined stage progression condition has been satisfied and wherein the theoretical Return To Player (RTP) of the game increases for each stage.

In an embodiment the RTP for one or more of a second or subsequent stage of the wager game is greater than 100%.

In an embodiment at least one of the stages is associated with a feature event which is awarded in response to a randomly occurring trigger being determined during play of the corresponding stage.

In an embodiment the same paytable parameters are used for determining standard game outcomes for each stage of the main game and wherein the increase in RTP is achieved through the setting of game play parameters associated with the feature event(s).

In an embodiment the increase in theoretical RTP is achieved, at least in part, through increasing a probability that the feature event will be triggered for each stage relative to the probability for triggering the feature event in the preceding stage.

In an embodiment the increase in theoretical RTP is achieved, at least in part, through increasing an actual or potential prize value of the feature event for each stage relative to the value for the preceding stage.

In an embodiment the feature event is awarded in response to determining a predefined symbol combination resulting through play of the game.

In an embodiment the feature event is awarded in response to a random trigger being determined, the random trigger being independent of a symbol driven outcome of the wager game.

In an embodiment each of the stages is associated with a feature event.

In an embodiment the method further comprises resetting play of the main game to a first of the plurality of stages in response to the feature event being awarded in a final stage of the main game and wherein awarding of the feature event in any of the other stages does not result in resetting play of the main game.

In an embodiment the method further comprises resetting play of the main game to a first of the plurality of stages in response to the feature event being awarded in a second or subsequent stage of the main game.

In an embodiment the method further comprises randomly determining whether to reset play of the main game to a first of the plurality of stages following the awarding of the feature event in a second or subsequent stage of the main game.

In an embodiment the method further comprises forcing the feature event to be awarded in the final stage of the main game after a predefined amount of gameplay has been reached without the trigger occurring.

In an embodiment, for a second or subsequent stage of the main game, the method further comprises randomly determining whether to reset play of the main game to a first of the plurality of stages following a play which has not resulted in the awarding of a feature event.

In an embodiment the random determination to reset play is only carried out after a minimum amount of gameplay has been carried out.

In an embodiment the minimum amount of gameplay relates to a predefined minimum number of wagers having been placed, the predefined minimum number being greater than 0.

In an embodiment, for at least one of the stages, the predefined stage progression condition is that a stage progression trigger has occurred either upon or following placement of a wager in the main game.

In an embodiment the stage progression trigger is that a predefined amount of gameplay has occurred.

In an embodiment the predefined amount of gameplay is that a set number of wagers have been placed in the corresponding stage.

In an embodiment the predefined amount of gameplay corresponds to a set accumulated amount of wagers for the corresponding stage.

In an embodiment the stage progression trigger is a randomly determined trigger.

In an embodiment the stage progression trigger is randomly determinable only after having surpassed a first number of plays of the corresponding stage.

In an embodiment the first number of plays is randomly determined within a predefined range.

In an embodiment the first number of plays is determined based, at least in part, on an evaluation of a value of the placed wager.

In an embodiment, if the randomly determined stage progression trigger has not occurred after a second number of wagers have been placed, the method further comprises forcing the trigger to occur, wherein the second number of wagers is greater than the first number of wagers.

In an embodiment a probability of the stage progression trigger being randomly determined varies according to the number of remaining plays before the second number of wagers is reached.

In an embodiment a probability of the stage progression trigger being randomly determined is based upon an amount of gameplay since the last feature event was awarded.

In an embodiment the method further comprises allowing a player to place a wager which is supplementary to a wager placed on the main game and wherein the probability of randomly determining the stage progression trigger is increased from the previous value responsive to determining the supplementary wager has been placed.

In an embodiment the method further comprises allowing a player to place a wager which is supplementary to a wager placed on the main game and wherein the predefined amount of gameplay is reduced responsive to determining the supplementary wager has been placed.

In an embodiment players are allowed to place supplementary wagers of different value and wherein there is a non-linear relationship between the supplementary wager value and reduction in amount of gameplay.

In an embodiment the method further comprises recording a value for each wager placed on the main game and wherein the recorded values are taken consideration in order to determine whether the stage progression condition has been met.

In an embodiment a requirement of the stage progression condition is that wagers of a consistent value are placed throughout the stage.

In an embodiment a play parameter for a feature event associated with one of the stages is different to a play parameter for a feature event associated with another one of the stages.

In an embodiment the method further comprises determining at least one of a total value and bet level for each wager placed on the main game and wherein in response to determining a change in the wager value/bet level in a second or subsequent stage the method comprises resetting play to a first of the stages.

In an embodiment the method further comprises setting play to the second or subsequent stage in which the change in wager value/bet level was determined responsive to the player subsequently placing a wager having the same value/bet level as the wager placed prior to the determined change.

In accordance with a second aspect there is provided computer executable code stored on a non-transitory storage medium for instructing a computer to perform a method of game play, including the steps of: displaying play of a wager game comprising a main game having a plurality of stages with progression through the stages being triggered responsive to determining that a predefined stage progression condition has been satisfied and wherein the theoretical Return To Player (RTP) of the game increases for each stage.

In accordance with a third aspect there is provided a computing apparatus having a central processing unit, associated memory and storage devices, and input and output devices, the apparatus being instructed by computer executable code stored on a non-transitory storage medium to perform a method of game play, including the steps of: displaying play of a wager game comprising a main game having a plurality of stages with progression through the stages being triggered responsive to determining that a predefined stage progression condition has been satisfied and wherein the theoretical Return To Player (RTP) of the game increases for each stage.

In accordance with a fifth aspect there is provided a gaming apparatus comprising: a display module operable to display play of a wager game comprising a main game having a plurality of stages; a controller operable to evaluate game play to determine whether a stage progression condition has been met and responsive thereto progress play to a subsequent stage, wherein the controller is operable to set parameters of the main game such that a theoretical Return To Player (RTP) increases for each stage thereof.

In an embodiment the method further comprises the RTP for one or more of a second or subsequent stage of the wager game is greater than 100%.

In an embodiment at least one of the stages is associated with a feature event which is awarded in response to a randomly occurring trigger being determined during play of the corresponding stage.

In an embodiment the same paytable parameters are used for determining standard game outcomes for each stage of the main game and wherein the increase in theoretical RTP is achieved through the setting of game play parameters associated with the feature event(s).

In an embodiment the increase in theoretical RTP is achieved, at least in part, through increasing a probability that the feature event will be triggered for each stage relative to the probability for triggering the feature event in the preceding stage.

In an embodiment the increase in theoretical RTP is achieved, at least in part, through increasing an actual or potential prize value of the feature event for each stage relative to the value for the preceding stage.

In an embodiment the feature event is awarded in response to determining a predefined symbol combination resulting through play of the game.

In an embodiment the feature event is awarded in response to a random trigger being determined, the random trigger being independent of a symbol driven outcome of the wager game.

In an embodiment each of the stages is associated with a feature event.

In an embodiment the controller is further arranged to reset play of the main game to a first of the plurality of stages in response to the feature event being awarded in a final stage of the main game and wherein awarding of the feature event in any of the other stages does not result in resetting play of the main game.

In an embodiment the controller is further operable to reset play of the main game to a first of the plurality of stages in response to the feature event being awarded in a second or subsequent stage of the main game.

In an embodiment the controller is further operable to randomly determine whether to reset play of the main game to a first of the plurality of stages following the awarding of the feature event in a second or subsequent stage of the main game.

In an embodiment the controller is further operable to force the feature event to be awarded in the final stage of the main game after a predefined amount of gameplay has been reached without the trigger occurring.

In an embodiment for a second or subsequent stage of the main game, the controller is further operable to randomly determine whether to reset play of the main game to a first of the plurality of stages following a play which has not resulted in the awarding of a feature event.

In an embodiment the random determination to reset play is only carried out after a minimum amount of gameplay has been carried out.

In an embodiment the minimum amount of gameplay relates to a predefined minimum number of wagers having been placed, the predefined minimum number being greater than 0.

In an embodiment, for at least one of the stages, the predefined stage progression condition is that a stage progression trigger has occurred either upon or following placement of a wager in the main game.

In an embodiment the stage progression trigger is that a predefined amount of gameplay has occurred.

In an embodiment the predefined amount of gameplay is that a set number of wagers have been placed in the corresponding stage.

In an embodiment the predefined amount of gameplay corresponds to a set accumulated amount of wagers for the corresponding stage.

In an embodiment the stage progression trigger is a randomly determined trigger.

In an embodiment the stage progression trigger is randomly determinable only after having surpassed a first number of plays of the corresponding stage.

In an embodiment the first number of plays is randomly determined within a predefined range.

In an embodiment the first number of plays is determined based, at least in part, on an evaluation of a value of the placed wager.

In an embodiment if the randomly determined stage progression trigger has not occurred after a second number of wagers have been placed, the controller is further arranged to force the trigger to occur, wherein the second number of wagers is greater than the first number of wagers.

In an embodiment a probability of the stage progression trigger being randomly determined varies according to the number of remaining plays before the second number of wagers is reached.

In an embodiment a probability of the stage progression trigger being randomly determined is based upon an amount of gameplay since the last feature event was awarded.

In an embodiment the controller is further operable to allow a player to place a wager which is supplementary to a wager placed on the main game and wherein the probability of randomly determining the stage progression trigger is increased from the previous value responsive to determining the supplementary wager has been placed.

In an embodiment the controller is further operable to allow a player to place a wager which is supplementary to a wager placed on the main game and wherein the predefined amount of gameplay is reduced responsive to determining the supplementary wager has been placed.

In an embodiment players are allowed to place supplementary wagers of different value and wherein there is a non-linear relationship between the supplementary wager value and reduction in amount of gameplay.

In an embodiment the controller is further operable to record a value for each wager placed on the main game and wherein the recorded values are taken consideration in order to determine whether the stage progression condition has been met.

In an embodiment a requirement of the stage progression condition is that wagers of a consistent value are placed throughout the stage.

In an embodiment a play parameter for a feature event associated with one of the stages is different to a play parameter for a feature event associated with another one of the stages.

In an embodiment the controller is further operable to determine at least one of a total value and bet level for each wager placed on the main game and wherein in response to determining a change in the wager value/bet level in a second or subsequent stage the method comprises resetting play to a first of the stages.

In an embodiment the controller is further operable to set play to the second or subsequent stage in which the change in wager value/bet level was determined responsive to the player subsequently placing a wager having the same value/bet level as the wager placed prior to the determined change.

An embodiment of the system further includes a central control for running a gaming algorithm, and a plurality of remote clients in communication with the central control over a communications network, the remote clients including screens for the display of information to players.

Embodiments of the present invention may be applied to any suitable type of gaming system or platform. It can apply to stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers, PDAs, mobile telephones, digital televisions, and the like, e.g. over the Internet or other communications networks.

Embodiments may be applied to gaming apparatus that play any suitable game, but especially relate to slot-machine type games.

In some networked embodiments of the invention, the central control may conduct the games and manage the accounting and the like, and a number of remote terminals/clients merely provide the user input and display mechanisms. In other networked embodiments of the invention, the control of the games and various other features may be carried out at the remote terminals, or may be split between the central control and the remote terminals.

### BRIEF DESCRIPTION OF THE ACCOMPANYING DRAWINGS

Embodiments of the invention will hereafter be described, by way of example only, with reference to the accompanying drawings, in which:

FIG. 1 is a block diagram of gaming apparatus according to one embodiment of the present invention;

FIG. 2 is a schematic of a game controller according to an embodiment; and

FIG. 3 is a flow diagram of a gaming control process in accordance with an embodiment of the present invention.

### DETAILED DESCRIPTION

In an embodiment a game controller of a gaming device comprises a display module operable to display play of a wager game comprising a main game having multiple stages which may each yield a feature sequence (depending on the desired implementation). For each stage of the main game, the controller is operable to evaluate certain game play parameters to determine whether a stage progression condition has been met and responsive thereto progress play to the subsequent stage. Unlike existing systems, each subsequent stage of the main game has an increased mathematically calculable Return to Player (RTP) percentage. In order to achieve the increase in RTP, either the normal game differs in some way from stage to stage, the feature play differs in some way from stage to stage, or both the normal game and feature play differs in some way from stage to stage.

General Construction of a Gaming System

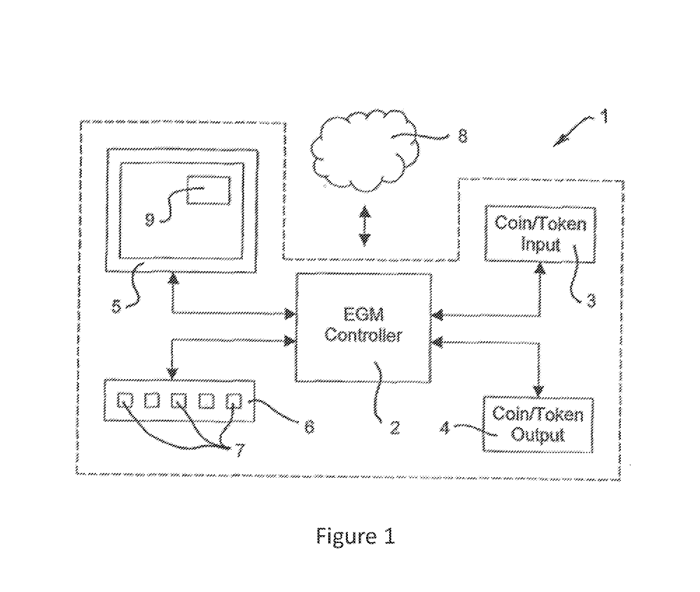

Referring to FIG. 1 there is shown a gaming apparatus, which in this case takes the form of an electronic gaming machine (EGM) 1, and which includes various standard components, such as a game controller 2 for controlling the operation of the EGM 1 and the games run on it, a note/coin/token input 3 for receiving bets, a note/coin/token output 4 for paying out winnings, one or more displays 5 for displaying game screens, and player input means 6 for allowing user interaction, which may include e.g. buttons 7 and which may e.g. be provided as part of the display 5 in a touch-screen type manner. The EGM 1 also includes a player tracking and marketing means 9 having a reading device (e.g. a card scanner for reading a smart card or other form of portable storage medium capable of being read by the card scanner) which communicates with a remote server for providing player tracking and loyalty type functions, as is well understood in the art. Additional hardware may be included as part of the EGM 1, or hardware may be omitted as required by the specific implementation.

In one form the EGM 1 may be a stand-alone machine. In another form, the EGM may be networked with other EGMs and/or a control centre via a suitable communications network 8, such as a LAN and/or WAN, in order to play networked (e.g. intranet or Internet) games, such as a linked jackpot. It will be appreciated that the EGM 1 may include an appropriate communications interface, such as a network card, for communicating over the communications network 8.

In use, the EGM 1 will display an initial interface for the game on the display 5. A player will insert bank notes, coins and/or tokens into the EGM input 3 (or may be credited with coins, credits or tokens), and will press a button 7 to initiate play of the main game provided by the EGM 1. How matters then proceed will depend on the type of staged main game being played. For example, for a slot machine-type game (i.e. in which the EGM 1 displays virtual reels of symbols), the controller 2 is programmed to spin and stop the reels, which will result in various win and lose symbol combinations on one or more paylines, in accordance with a stored gaming algorithm and a random number generator. In an alternative embodiment (not illustrated) the main game is a poker-type game, in which a player will receive a number of cards with which to play for a winning hand. For the purposes of this detailed description, the main focus shall be upon an embodiment providing a slot machine-type main game having multiple stages. As used in this document, including in the claims, the terms “random”, “randomly”, “randomized”, and the like, are to be construed as connoting either a purely random process or a “pseudo-random” process. An example of a pseudo-random process includes the determination by a computer processor of a pseudo-random number in response to an output of a digital clock.

The player may interact via the buttons 7, so as e.g. to spin or hold reels and otherwise play the main game. A common element will be win events, e.g. particular symbol combinations that are randomly generated and which pay out a prize.

The main game may include one or more wild symbols that can represent more than one type of symbol, and so can increase the chances of achieving a winning combination or the like. Similarly, for embodiments in which the main game is a card game, wild cards may be provided. Also, to increase interest, the each of the main game stages may be capable of providing a feature event (also referred to as feature sequences) that consist of one or more feature games, which may or may not relate directly to the corresponding main game stage being played, and that generally provide a prize of some sort or have a heightened chance of yielding a prize or a prize value in comparison to the main game. These feature events may include for example one or more free games, a re-spin (similar to a free game but with one or more reels held on a slot device), and the chance to play for higher winnings or the like (e.g. in a higher-payout game that may require additional wagering). They may be e.g. luck or skill based. They may be provided as “second screen” features that display on a new screen, and may be extraneous to the main game and may involve some form of player interaction.

These win and feature events can be arranged to occur due to the usual operation of the main game randomly or under a particular set of circumstances, e.g. when a predefined symbol combination occurs after a spin of the reels, or a predefined card combination occurs in a card game. They may also occur due to an accumulation of circumstances across a number of games, and may occur due to the condition of a device supplemental to the EGM 1 itself, e.g. they may relate to jackpot wins in linked jackpot systems comprising a plurality of EGMs under a central control.

FIG. 1 illustrates an essentially stand-alone EGM (albeit with the potential for networked connectivity). However, in an alternative embodiment the system may be implemented over a distributed architecture where some of the individual EGM modules are implemented remotely. For example, in one particular form, a central control computer which is located remotely of the EGM may implement a controller which controls some or all of the game play functionality (i.e. such that the EGM essentially operates as a remote client arranged to provide audible and/or visual gaming information to a player and allow player interaction with the central control computer). A plurality of EGM clients may be in communication with the central control computer over a communications network such as a local area network and/or a wide area network. In an alternative embodiment, the game play functionality may be implemented by both the EGM and central control computer such that they collectively provide a game controller.

The central control computer has access to associated memory and storage devices. The central control computer also has access to computer executable code for instructing the central control computer to run the gaming algorithm that performs the embodiment of the inventive method. In one embodiment the computer executable code is in the form of software and associated data, which are stored upon a computer-readable medium in the form of one or more compact disks. Alternative embodiments make use of other forms of digital storage media, such as Digital Versatile Discs (DVD's), hard drives, flash memory, Erasable Programmable Read-Only Memory EPROM, and the like. Alternatively, the software and its associated data may be stored as one or more downloadable or remotely executable files that are accessible via a computer communications network such as the internet.

Detail of the Game Controller

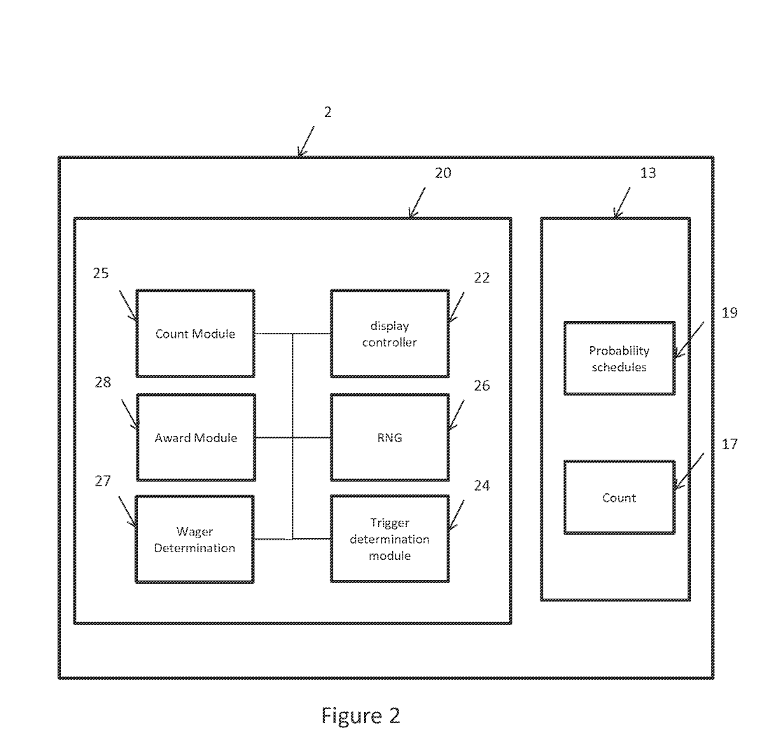

The game controller 2 of an embodiment is shown in more detail in FIG. 2. For simplicity only those modules (which may be implemented in hardware, software, or a combination of the two) needed to carry out embodiments are illustrated. Other standard and/or non-standard modules may also be implemented for carrying out operation of normal and feature game play functionality. It will be understood that the term “processor” as used herein is to be construed broadly and include within its scope any device that can process gaming algorithms and may include a microprocessor, microcontroller, programmable logic device or other computational device, a general purpose computer, or a server computer. Typically, the gaming algorithms (instructions) are stored as program code in memory 13, which is in data communication with the processor.

In the illustrated embodiment, the game controller 2 includes a processor 20 which is arranged to control play of a main game (also commonly referred to as a “base game”) having multiple stages, with progression through each main game stage being triggered responsive to determining that a stage progression condition has been met. The multi-stage main game implements an enhanced payout structure whereby a theoretical Return to Player (RTP) for the game increases as play progresses through the various stages of the game (i.e. such that the mathematically calculable RTP for each stage is higher than the mathematically calculable RTP of the preceding stage). As will become evident from the following description, the increase in RTP can be achieved in a number of ways including, but not limited to, adjusting non-feature related parameters of the main game stages (e.g. paytable values, symbol sets, etc.), adjusting parameters related to feature events triggerable for the main game stages (e.g. a likelihood of triggering the feature for a particular stage, a potential or actual prize value for the feature, etc.), or a combination of the two.

To facilitate the above functionality, the processor 20 implements a number of modules, based on program code stored in memory 13. A display module 22 is operable to provide the display of the multi-stage game implemented by the controller 2. A trigger module 24 is arranged to set stage progression triggers, feature event triggers, reset stage triggers and also to detect the occurrence of such triggers during play of the game. The various triggers may be set by the trigger module 24 with the aid of the random number generator 26, where applicable. A count module 25 keeps track of play count (in this case the number of spins) and stage count. A wager determination module 27 keeps track of wagers placed by players throughout the game. Finally, an award module 28 is operable to prizes resulting through play of the game.

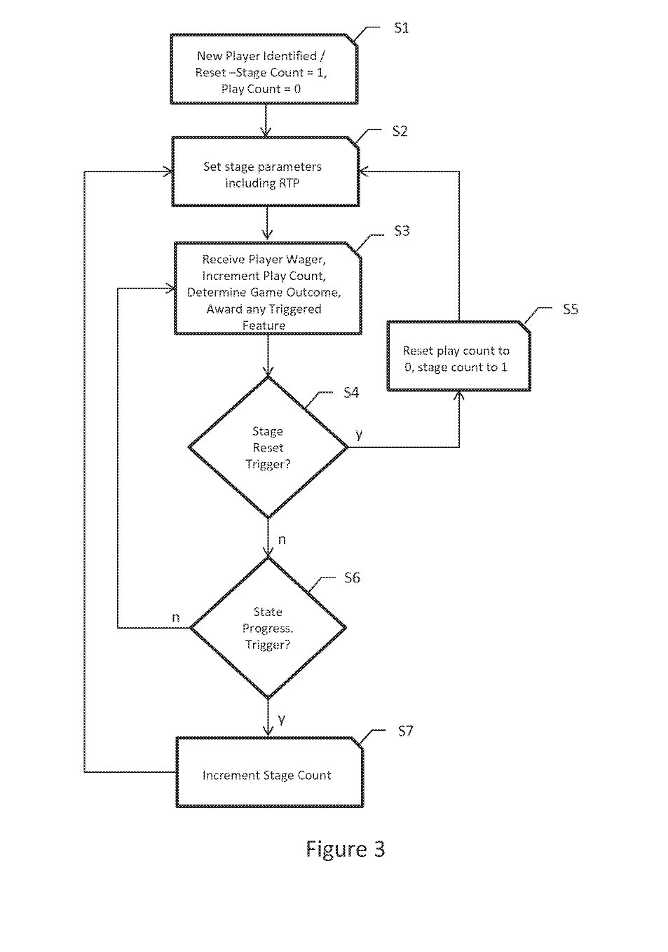

A general process flow of an embodiment will now be described with additional reference to the flowchart of FIG. 3.

In a first step S1, the game controller 2 determines that a new player (e.g. through an evaluation of the player identification data input via the player tracking and marketing reader 9) is interfacing with the EGM 1. The game controller 2 subsequently instructs the count module 25 to set the stage count to “1” and the play count to “0”.

At step S2 the play parameters for the stage are subsequently applied and the corresponding stage artwork is displayed to the player. By way of example only, the play parameters for the first stage may result in an RTP of 87%.

At step S3 the game controller 2 receives a player wager. In response, the game controller 2 instructs the count module 25 to increment the play count and the wager determination module 27 records a value of the wager. The game controller 2 subsequently determines a game outcome of the corresponding stage (with the aid of the RNG 26) and the result is displayed to the player. The award module 28 awards any resulting prizes.

At step S4, the trigger determination module 24 evaluates whether a stage reset condition has been satisfied. In a particular embodiment, the stage reset condition will only be evaluated for a second or subsequent stage of the game. It will be understood that the stage reset condition may vary depending on the desired implementation, but may, for example, be satisfied in response to the triggering of a feature event, in response to a random determination after a feature event has been triggered, in response to a random determination upon or following a play which has not resulted in a feature event being triggered, responsive to a set amount of gameplay (e.g. spins, wins, cumulative wager amount, etc.) having been reached, or any combination of the above.

If the stage reset condition has been satisfied, the game controller 2 instructs the count module to reset the stage count to “1” and play count to “0” (step S5). The game process then returns to step S2 (assuming that the same player continues to play the multi-stage game). If the stage reset condition has not been satisfied, the game process proceeds to step S6.

At step S6, the trigger determination module 24 evaluates whether a stage progression condition has been satisfied. As for the stage reset condition, the stage progression condition can vary depending on the desired implementation. By way of example, the stage progression condition may be satisfied in response to determining that some predefined amount of gameplay has occurred (e.g. a certain number of spins have been played, dollars have been wagered, credits have been won, etc.). Alternatively, the progression condition may be determined based on a random determination, e.g. in response to a randomly occurring progression trigger being determined. In one particular embodiment, the randomly occurring progression trigger may, for example, only be triggerable after some predefined or randomly-ranged initial amount of gameplay has been reached. For example, some predefined number of spins must have been played before the trigger determination module 24 will start to monitor for the stage progression trigger. In yet another particular embodiment, the progression trigger may be forced to occur by a predefined or randomly-ranged maximum amount of gameplay. For example, the trigger determination module 24 starts monitoring after some predefined number of spins and automatically forces triggering of stage progression if the randomly occurring trigger hasn't been determined before some predefined maximum number of spins.

The likelihood of the randomly occurring progression trigger being determined may be programmed to increase as the amount of gameplay gets closer to the predetermined maximum amount (e.g. based on an evaluation of a probability schedule stored in memory). In a particular embodiment, the probability schedule may be configured such that the probability of triggering varies in dependence upon an amount of gameplay (e.g. spins, accumulated wagers, wins, etc.) since the last feature event was awarded. In one embodiment players can improve the likelihood of the progression trigger occurring by placing a supplementary wager.

If at step S6 the stage progression condition has not been met, then the process returns to Step S3. If the stage progression condition has been met, at step S7 the game controller 2 instructs the count module 25 to increment the stage count and the controller 2 configures the relevant parameters of the game for implementing the next stage of the game. As mentioned above, the next stage has an increased theoretical RTP percentage than the previous stage. By way of example, stage 2 may have an RTP of 90% (i.e. representing a 3% increase relative to the previous stage). The process then returns to step S3 as afore-described.

It will be understood that in an alternative embodiment to that described above with reference to FIG. 3, the stage progression condition could be determined upon (i.e. rather than following) placement of a wager by the player at step S2.

In another alternative embodiment, the game controller 2 may be programmed to continue progression through the stages irrespective of whether the credit meter has reached zero at any time, or whether a different player has commenced play on the EGM 1 (e.g. detected through means such as a player tracking card). In this alternative embodiment the stage count will simply continue from previous play.

A number of specific non-limiting example embodiments of the invention will now be described to illustrate different techniques for increasing the stage RTP, as well as illustrating various stage reset and progression trigger determinations.

### EXAMPLE 1

In this example the main game is in the form of a reel-type game having a “Chinese Dragon” theme. There are five distinct stages of the main game; the first four stages corresponding to seasons of the year and the final stage being a Dragon theme stage. A feature event (hereafter “free game feature”) is randomly triggerable in each of the five stages. The feature event for the final stage has a theoretical RTP per spin which is greater than 100% which is compensated by relatively low RTPs for the earlier stages. An average of all wager values placed since the last reset (to the start of stage 1) is used to calculate the wager used upon a feature event being triggered.

Play progresses as follows:
Play commences at base game stage 1 (themed to, and called, “Winter”)
If the feature event does not trigger (i.e. by achieving an appropriate predetermined symbol combination or other suitable trigger event) within 99 spins (i.e. plays of the game), then after the 99th spin the game is progressed to base game stage 2 (“Spring”)
Base game stage 2 has a higher theoretical RTP than stage 1, and includes different feature parameters to stage 1.
If a feature does not trigger within 99 spins in base game stage 2, then after the 99th spin the game is progressed to base game stage 3 (“Summer”)
Base game stage 3 has a higher theoretical RTP than each of stages 1 and 2, and includes different feature parameters to each of stages 1 and 2.
If a feature does not trigger within 99 spins in base game stage 3, then after the 99th spin the game is progressed to base game stage 4 (“Autumn”)
Base game stage 4 has a higher theoretical RTP than each of stages 1, 2 and 3, and includes different feature parameters to each of stages 1, 2 and 3.
If a feature does not trigger within 99 spins in base game stage 4, then after the 99th spin the game is progressed to base game stage 5 (“Dragon of the Center”)
Base game stage 5 has a higher theoretical RTP than each of stages 1, 2, 3 and 4, and includes different feature parameters to each of stages 1, 2, 3 and 4, and the theoretical RTP per spin is greater than 100%.
If a feature does not trigger (through random results) within 99 spins in base game stage 5 then the feature is triggered.
After playing any feature in stages 2 through to stage 5, the game reverts to stage 1. Any trigger in stage 1 would reset any accumulation towards progression to stage 2.

### EXAMPLE 2

In this example the main game is in the form of a reel-type game having a “Werewolf Rabbit” theme. In this example there are three distinct main game stages. A free game feature is randomly triggerable only in the second and third stage. Again, the feature event for the final stage has a theoretical RTP per spin which is greater than 100%.

Play progresses as follows:
Play commences at base game stage 1 (themed to a happy cartoon rabbit village, and called, “Another Sunny Day in Bunnyville”)
No check is made by the trigger determination module 24 for stage progression until 80 paid spins (plays of the game) have been made.
After 80 spins the trigger determination module 24 starts to check for progression to base game stage 2. In a particular embodiment, a maximum of 160 spins will take place in base game stage 1 before forcing the stage progression trigger to occur, and the chance to progress is (1/(the number of spins remaining until the guaranteed trigger)), where that chance to progress is checked at the end of a paid game play.
Upon determining that the stage progression condition has been met, the game enters base game stage 2 (“Night is Falling”).
Base game stage 2 has a higher theoretical RTP than base game stage 1, and the game play parameters are changed to introduce a feature event to the game.
No check for progression is made until 80 paid spins (plays of the game) have been made in base game stage 2. Any trigger of the stage 2 feature event during random play of the game will play the stage 2 feature and then reset the game to the start of base game stage 1.
After 80 spins in base game stage 2 in which no feature event has been triggered during random play, the trigger determination module 24 starts to check for progression to base game stage 3. In a particular embodiment, a maximum of 160 spins will take place in base game stage 2, and the chance to progress is (1/(the number of spins remaining until a guaranteed trigger)), where that chance to progress is checked at the end of a paid game play and where no feature has been triggered during this random play of the game.
Upon determining that the stage progression condition has been met for stage 2, the game enters base game stage 3 (“Rise of the Werewabbits”)
Base game stage 3 has a higher theoretical RTP than each of stages 1 and 2, and includes different feature parameters to each of stages 1 and 2 and the theoretical RTP per spin is greater than 100%.
Any trigger of the stage 3 feature event during random play of the game will play the stage 3 feature and then reset the game to the start of base game stage 1.
If a feature does not trigger (through random results) after 80 spins of the game in base game stage 3 then there is a chance that the game will revert to the start of base game stage 1 after any play of the game in which a feature is not triggered through random result.
In a particular version, a minimum of 80 and a maximum of 160 spins will take place in base game stage 3, and the chance to revert after 80 spins is (1/(the number of spins remaining until a guaranteed trigger)), where that chance to progress is checked by the trigger determination module 24 at the end of a paid game play. After either triggering a feature through random play in base game stage 3, or at the end of the 160th play of the game in base game stage 3 in which no feature was triggered through random play, the game is reset to the start of base game stage 1.

In an alternative version of Example 2, a feature event is triggerable in the first stage. Responsive to the feature event being triggered within the 80 spins, the game controller 2 may instruct the count module to reset the 80 spin count (which is not visible to the player). Such an alternative version may also employ a maximum number of spins before forcing the stage progression trigger. For example, a maximum of 160 spins will take place in base game stage 1, and the chance to progress is (1/(the number of spins remaining until the guaranteed trigger)), where the chance to progress is checked at the end of a paid game play and where no feature event has been triggered during this period of game play.

In yet another alternative version of Example 2, the wager determination module 27 is configured to track each bet level when playing in base game stage 1. Each bet level (e.g.: 1 c per line versus 2 c per line) is accrued distinct from other bet levels in regards to the progression towards base game stage 2 (i.e.: playing 70 spins at 1 c per line and then changing to 2 c per line will start a new 80-spin progression meter until there is a chance to progress to base game stage 2. If the player changes back to 1 c per line then accrual would resume at the 70-spins-completed level). Changes to bets are allowed in stage 1, as above, but as soon as stage 2 is entered bets cannot be changed.

### EXAMPLE 3

In this example the main game is in the form of a reel-type game having a comical “Meerkat” theme. In this example there are four distinct game stages. A free game feature is randomly triggerable only in the second and third stage. Again, the feature event for the final stage has a theoretical RTP per spin which is greater than 100%. According to this example, changes to bet levels are allowed during base game stage 1 play only. As soon as the base game stage 1 feature is triggered through random play, the bet level is locked (cannot be adjusted) until such time as the game reverts to base game stage 1.

Play progresses as follows:
Play commences in base game stage 1 (“Scout”).
A feature event is triggered during play by achieving a particular predefined symbol combination (e.g. three “Bonus” symbols anywhere on the reel grid following a spin of the reels).
Upon triggering the feature event, the stage 1 “Scout” feature is played and the game is then progressed to base game stage 2 (“Hunter”).
Base game stage 2 has a higher theoretical RTP than base game stage 1, but the theoretical RTP for the non-feature component (symbol combination pays in normal “non feature” play) is the same. The win potential (likelihood that a win is achieved, and/or likelihood that the win returns a comparatively higher amount) is higher than the feature event in base game stage 1.
As with base game stage 1, a feature event may be triggered in base game stage 2 during play by achieving a particular predefined symbol combination.
Upon triggering the feature event, the stage 2 “Hunter” feature is played and the game is then progressed to base game stage 3 (“Muscle”).
Base game stage 3 has a higher theoretical RTP than base game stages 1 and 2, but the theoretical RTP for the non-feature component (symbol combination pays in normal “non feature” play) is the same as the earlier stages. The win potential (likelihood that a win is achieved, and/or likelihood that the win returns a comparatively higher amount) is higher than the feature in base game stage 1 and 2.
As with base game stage 1 and 2, a feature event may be triggered in base game stage 3 during play by achieving a particular predefined symbol combination (e.g. three “Bonus” anywhere on the grid of symbol following a spin of the reels).
Upon triggering the feature event, the stage 3 “Muscle” feature is played and the game is then progressed to base game stage 4 (“Commander”).
Base game stage 4 has a higher theoretical RTP than base game stages 1, 2 and 3, but the theoretical RTP for the non-feature component (symbol combination pays in normal “non feature” play) is the same as the earlier stages. The win potential (likelihood that a win is achieved, and/or likelihood that the win returns a comparatively higher amount) is higher than the feature in base game stage 1, 2 and 3. The overall theoretical RTP in stage 4 is over 100%.
As with base game stage 1, 2 and 3, a feature event may be triggered in base game stage 3 during play by achieving a particular predefined symbol combination.
Upon triggering the feature, the stage 4 “Commander” feature is played and the game is then reverts to base game stage 1.

In a variant of the above example, the player may “abandon” their higher-stage play and manually revert to the base game stage 1, e.g. by selecting an appropriate button on the EGM display. For instance, a player may wish to play a higher bet, but has triggered a feature in base game stage 1 while playing an occasionally-played lower wager. For such a player, the higher stage play at the lower bet may not be as enticing or exciting, and thus they may wish to abandon such play, even though it has a theoretical RTP advantage.

It will be understood that certain embodiments may not incorporate the forced feature trigger in the final stage (i.e. such that after the maximum number of games has been reached, play simply returns to the initial stage without any free games being awarded). It will also be appreciated that in certain embodiments play may be reset to a stage other than the initial stage. For example, a random determination may be made as to whether play is to be reset to the initial stage or to some other stage.

In an alternative embodiment to that described above, different types of feature event may be applied to different stages. For example, the feature event associated with a first stage may be a series of free games, the feature event for the second stage may be a reel re-spin feature, the feature event for the third stage may be an instant prize, etc. It will be understood that the form of feature event should not be seen as being limited to those events described above and could be any form of in-game feature or externally triggered and awarded feature (e.g. the triggering of a jackpot prize such as a mystery jackpot prize, etc.), depending only on the desired implementation.

In a particular embodiment, in order to ensure that the mathematical system is not corrupted by placing lower wagers in lower RTP stages and then higher wagers in higher RTP stages, the game controller 2 may be programmed to control game play (and corresponding parameters) such that feature event award parameters are set based on an average wager value for all wagers placed since the last “reset to stage 1” event. Alternatively, progression through each stage is monitored and accrued on the basis of each individual magnitude of wager or wager level. If a player changes their wager in a higher stage, for example, this may restart accrual in stage 1, and may revert to the higher stage only when the player reverts to the original wager level. As yet another alternative mechanism the game may only accept wagers of a particular fixed value (e.g. all wagers on the game are $1.)

It will also be appreciated that various play parameters may or may not have an impact on the RTP of the corresponding stage, depending on the desired implementation, subject to at least one of the play parameters resulting in an increase to the theoretical RTP in the successive stage. Further, it will be understood that the actual main game played in each stage may take on an entirely different form (e.g. a first stage could be a reel-type game, a second game could be a card game and so on).

For example, bonus, wild or paying symbols that may be specific to a particular stage may be added to a feature event triggered in a later stage, and/or paying combinations applicable to a particular stage may be incorporated in a feature event triggered in a later stage, and/or bonus “second screen”, re-spin and other “feature within feature” events that may be triggerable while within a feature and which may normally be applicable to a particular stage may be incorporated in a feature event triggered in a later stage. Alternatively, the single feature event may have one or more play parameters which are set based on how many stages have been played by the player. For example, where the feature event is a series of free games, the number of free games awarded may in part depend on how many stages have been played. Other non-limiting examples include increasing or changing the prize multiplier applied to prizes during the feature event based on how many stages have been played, and/or increasing or changing the number or function of wild symbols based on how many stages have been played.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by a person skilled in the art.

1. A method of gaming comprising:
displaying play of a wager game comprising a main game having a plurality of stages with progression through the stages being triggered responsive to determining that a predefined stage progression condition has been satisfied and wherein the theoretical Return To Player (RTP) of the game increases for each stage.

2. A method in accordance with claim 1, wherein the RTP for one or more of a second or subsequent stage of the wager game is greater than 100%.

3. A method in accordance with claim 1, wherein at least one of the stages is associated with a feature event which is awarded in response to a randomly occurring trigger being determined during play of the corresponding stage.

4. A method in accordance with claim 3, wherein the same pay table parameters are used for determining standard game outcomes for each stage of the main game and wherein the increase in RTP is achieved through the setting of game play parameters associated with the feature event(s).

5. A method in accordance with claim 4, wherein the increase in RTP is achieved, at least in part, through increasing a probability that the feature event will be triggered for each stage relative to the probability for triggering the feature event in the preceding stage.

6. A method in accordance with claim 4, wherein the increase in RTP is achieved, at least in part, through increasing an actual or potential prize value of the feature event for each stage relative to the value for the preceding stage.

7. A method in accordance with claim 3, wherein each of the stages is associated with a feature event.

8. A method in accordance with claim 3, further comprising resetting play of the main game to a first of the plurality of stages in response to the feature event being awarded in a final stage of the main game and wherein awarding of the feature event in any of the other stages does not result in resetting play of the main game.

9. A method in accordance with claim 3, further comprising resetting play of the main game to a first of the plurality of stages in response to the feature event being awarded in a second or subsequent stage of the main game.

10. A method in accordance with claim 3, further comprising randomly determining whether to reset play of the main game to a first of the plurality of stages following the awarding of the feature event in a second or subsequent stage of the main game.

11. A method in accordance with claim 3, further comprising forcing the feature event to be awarded in the final stage of the main game after a predefined amount of gameplay has been reached without the trigger occurring.

12. A method in accordance with claim 3, wherein for a second or subsequent stage of the main game, the method further comprises randomly determining whether to reset play of the main game to a first of the plurality of stages following a play which has not resulted in the awarding of a feature event.

13. A method in accordance with claim 12, wherein the random determination to reset play is only carried out after a minimum amount of gameplay has been carried out.

14. A method in accordance with claim 3, wherein a play parameter for a feature event associated with one of the stages is different to a play parameter for a feature event associated with another one of the stages.

15. A method in accordance with claim 1, further comprising determining at least one of a total value and bet level for each wager placed on the main game and wherein in response to determining a change in the wager value/bet level in a second or subsequent stage the method comprises resetting play to a first of the stages.

16. A method in accordance with claim 15, further comprising setting play to the second or subsequent stage in which the change in wager value/bet level was determined responsive to the player subsequently placing a wager having the same value/bet level as the wager placed prior to the determined change.

17. Computer executable code stored on a non-transitory storage medium for instructing a computer to perform a method of game play, including the steps of:
displaying play of a wager game comprising a main game having a plurality of stages with progression through the stages being triggered responsive to determining that a predefined stage progression condition has been satisfied and wherein the theoretical Return To Player (RTP) of the game increases for each stage.

18. A computing apparatus having a central processing unit, associated memory and storage devices, and input and output devices, the apparatus being instructed by computer executable code stored on a non-transitory storage medium to perform a method of game play, including the steps of:
displaying play of a wager game comprising a main game having a plurality of stages with progression through the stages being triggered responsive to determining that a predefined stage progression condition has been satisfied and wherein the theoretical Return To Player (RTP) of the game increases for each stage.

19. Gaming apparatus comprising:
a display module operable to display play of a wager game comprising a main game having a plurality of stages;
a controller operable to evaluate game play to determine whether a stage progression condition has been met and responsive thereto progress play to a subsequent stage, wherein the controller is operable to set parameters of the main game such that a theoretical Return To Player (RTP) increases for each stage thereof.

20. A gaming apparatus in accordance with claim 19, wherein the RTP for one or more of a second or subsequent stage of the wager game is greater than 100%.

21. A gaming apparatus in accordance with claim 19, wherein at least one of the stages is associated with a feature event which is awarded in response to a randomly occurring trigger being determined during play of the corresponding stage.

22. A gaming apparatus in accordance with claim 21, wherein the same paytable parameters are used for determining standard game outcomes for each stage of the main game and wherein the increase in RTP is achieved through the setting of game play parameters associated with the feature event(s).

23. A gaming apparatus in accordance with claim 22, wherein the increase in RTP is achieved, at least in part, through increasing a probability that the feature event will be triggered for each stage relative to the probability for triggering the feature event in the preceding stage.

24. A gaming apparatus in accordance with claim 22, wherein the increase in RTP is achieved, at least in part, through increasing an actual or potential prize value of the feature event for each stage relative to the value for the preceding stage.

25. A gaming apparatus in accordance with claim 19, wherein the controller is further operable to record a value for each wager placed on the main game and wherein the recorded values are taken consideration in order to determine whether the stage progression condition has been met.
